(19) United States
(12) Patent Application Publication
(10) Pub. No.: US 2025/0157406 A1
(43) Pub. Date: May 15, 2025

(54) TIMING CONTROLLER, DISPLAY DRIVING DEVICE AND DISPLAY DEVICE INCLUDING THE SAME

(71) Applicant: SAMSUNG ELECTRONICS CO., LTD., Suwon-si (KR)

(72) Inventors: Seung-Hoon Kim, Suwon-si (KR); Sangin Jeon, Suwon-si (KR)

(21) Appl. No.: 18/799,746

(22) Filed: Aug. 9, 2024

(30) Foreign Application Priority Data
Nov. 9, 2023 (KR) 10-2023-0154466

(51) Int. Cl. G09G 3/3258

(52) U.S. Cl. CPC G09G 3/3258; G09G 2310/08; G09G 2330/021; G09G 2330/028

(57) ABSTRACT

A timing controller according to an embodiment includes a non-volatile memory configured to store pulse data including information about at least one of information about the number of toggling of each signal in a plurality of horizontal periods, information about a logic level, and information about a period corresponding to the logic level, and a pulse generator configured to generate control signals corresponding to the plurality of horizontal periods based on the pulse data.

### CROSS-REFERENCE TO RELATED APPLICATION

This application claims priority to Korean Patent Application No. 10-2023-0154466 filed in the Korean Intellectual Property Office on Nov. 9, 2023, the entire contents of which are incorporated herein by reference.

### BACKGROUND

### (a) Field

The present disclosure relates to a timing controller and a display driving device and a display device including the same.

### (b) Description of Related Art

Generally, a display panel displays images and provides visual information to users. The display panel includes a plurality of pixels, and each of the plurality of pixels expresses light of a predetermined luminance to display an image. A display driver integrated circuit (IC, DDI) is used to drive pixels.

To support various display modes, gate drivers may receive various patterns of gate control signals, generate various patterns of gate signals based on the gate control signals, and apply the various patterns of gate signals to pixels. However, using hardwired structures to generate various gate control signals may result in increased power consumption and area overhead.

### SUMMARY

The present disclosure provides a display driving device and a display device generating gate signals of various patterns.

The present disclosure provides a timing controller reducing power and area overhead, and a display driving device and a display device including the same.

In some implementations, using a timing controller can prevent increased power consumption and area overhead. In a general aspect, a timing controller includes: a non-volatile memory configured to store pulse data including information about at least one of information about the number of toggling of each signal in a plurality of horizontal periods, information about a logic level, and information about a period corresponding to the logic level; and a pulse generator configured to generate control signals corresponding to the plurality of horizontal periods based on the pulse data.

In another general aspect, a display driving includes: a gate driver configured to generate a gate signal to be applied to a pixel based on a gate control signal; and a timing controller configured to count a plurality of horizontal synchronizing signals indicating a plurality of horizontal periods, and generate the gate control signal based on information about the waveform of the gate control signal corresponding to the horizontal period corresponding to the counting value among the plurality of horizontal periods.

In another general aspect, a display device includes: a pixel array including a gate line and a plurality of pixels connected to the gate line; a gate driver configured to output a gate signal to the gate line based on a gate driver control signal; and a timing controller configured to control a voltage level of the gate driver control signal based on pulse data indicating a pattern of a signal within a period corresponding to each of a plurality of horizontal periods.

### BRIEF DESCRIPTION OF THE DRAWINGS

FIG. 1 is a block diagram of an example of a display device.

FIG. 2 is a block diagram showing examples of configurations in a timing controller.

FIG. 3 is a table showing an example of pulse data.

FIG. 4 is a timing diagram showing an example of a pulse signal generated based on pulse data.

FIG. 5 is a table showing an example of pulse data.

FIG. 6 is a timing diagram showing an example of a pulse signal generated based on pulse data.

FIG. 7 is a table showing an example of pulse data.

FIG. 8 is a timing diagram showing an example of a pulse signal generated based on pulse data.

FIG. 9 is a table showing an example of pulse data.

FIG. 10 is a timing diagram showing an example of a pulse signal generated based on pulse data.

FIG. 11 is a block diagram showing examples of configurations in a timing controller.

FIG. 12 is a block diagram showing examples of configurations in a timing controller.

FIG. 13 is a block diagram specifically showing examples of configurations in a timing controller.

FIG. 14 is a block diagram showing examples of configurations in a timing controller.

FIG. 15 is a block diagram showing examples of configurations in a timing controller.

FIG. 16 is a block diagram showing examples of configurations in a timing controller.

FIG. 17 is a block diagram specifically showing examples of configurations in a timing controller.

FIG. 18 is a table showing an example of pulse data.

FIG. 19 is a table showing an example of changed pulse data.

FIG. 20 is a timing diagram showing an example of a pulse signal generated based on pulse data.

FIG. 21 is a diagram of an example of a display system.

The drawings and description are to be regarded as illustrative in nature and not restrictive. Like reference numerals designate like elements throughout the specification. In the flowchart described with reference to drawings in this description, the operation order may be changed, several operations may be merged, certain operations may be divided, and specific operations may not be performed.

### DETAILED DESCRIPTION

In the description, expressions described in the singular in this specification may be interpreted as the singular or plural unless an explicit expression such as “one” or “single” is used. Although terms of “first,” “second,” and the like are used to explain various constituent elements, the constituent elements are not limited to such terms. These terms are only used to distinguish one constituent element from another constituent element.

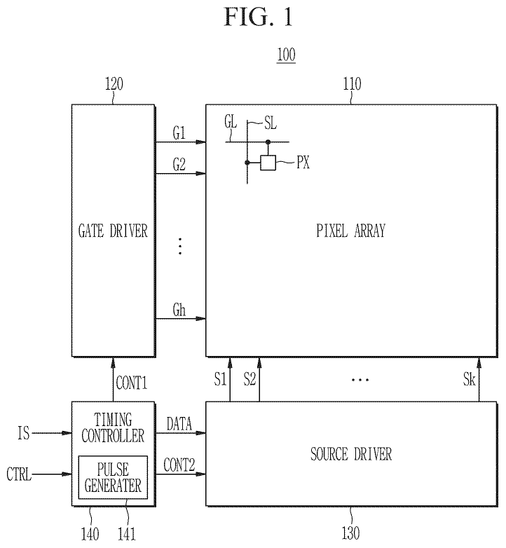

FIG. 1 is a block diagram of an example of a display device.

Referring to FIG. 1, a display device 100 includes a pixel array 110, a gate driver 120, a source driver 130, and a timing controller 140.

A plurality of pixels PX for displaying an image may be located in the pixel array 110. The pixel PX may be connected to a corresponding source line SL among a plurality of source lines and a corresponding gate line GL among a plurality of gate lines. The pixel PX may receive a data signal from the source line SL when the gate signal is supplied to the gate line GL. The pixel PX may express light of a predetermined luminance corresponding to an input data signal. The plurality of pixels PX may display an image by a frame unit.

If the display device 100 is an organic light emitting display device, each of the pixels PX may include a plurality of transistors including a driving transistor and an organic light emitting diode. The driving transistor included in the pixel PX supplies current corresponding to the data signal to the organic light emitting diode, and thus the organic light emitting diode may emit light with a predetermined luminance. If the display device 100 is a liquid crystal display device, each of the pixels PX may include a switching transistor and a liquid crystal capacitor. The pixel PX may control the transmittance of the liquid crystal in response to the data signal so that light of a predetermined luminance is supplied to the outside.

In FIG. 1, the pixel PX is shown as being connected to one source line SL and one gate line GL, but the connection structure of a signal line of the pixel PX of the display device is not limited thereto. For example, various signal lines may be additionally connected in accordance with the circuit structure of the pixel PX. In some implementations, the pixel PX may be implemented in various forms currently known.

The gate driver 120 may provide a plurality of gate signals G1, G2, . . . , Gh. The plurality of gate signals G1, G2, . . . , Gh may be pulse signals having an enable level and a disable level. The plurality of gate signals G1, G2, . . . , Gh may be applied to a plurality of gate lines GL.

In some implementations, when an enable level gate signal is applied to the gate line GL connected to the pixel PX, the pixel PX may perform various operations. The pixel PX may be connected to a plurality of gate lines. Gate signals for performing various operations may be provided through different gate lines GL connected to one pixel PX. For example, when an enable level gate signal is applied to the gate line GL connected to the pixel PX, the data signal applied to the source line SL connected to the pixel PX may be transmitted to the pixel PX. As another example, when an enable level gate signal is applied to the gate line GL connected to the pixel PX, the pixel PX may start emitting light. As another example, when an enable level gate signal is applied to the gate line GL connected to the pixel PX, the pixel PX may initialize at least one node. Hereinafter, it will be described that the enable level of the gate signal is a low level and the disable level is a high level.

The gate driver 120 may provide a plurality of gate signals G1, G2, . . . , Gh during a plurality of horizontal periods. One frame may include a plurality of horizontal periods. The number of horizontal periods may be greater than or equal to the number of gate lines GL.

The gate driver 120 may generate a plurality of gate signals G1, G2, . . . , Gh having various patterns. Here, the pattern of the gate signal may mean the waveform of the gate signal supplied to one gate line within at least one frame. The gate driver 120 may generate gate signals toggling various times within one frame. In some implementations, the gate driver 120 may generate gate signals with different patterns corresponding to various display modes. For example, the gate driver 120 may generate a gate signal having a first pattern in response to a normal mode and generate a gate signal having a second pattern different from the first pattern in response to a variable refresh rate (VRR) mode that varies the frame rate. A gate signal having the first pattern and a gate signal having the second pattern may be applied to the same gate line in each of normal mode and VRR mode.

The gate driver 120 may generate a plurality of gate signals G1, G2, . . . , Gh based on a gate driver control signal CONT1. In some implementations, the gate driver 120 may receive the gate driver control signal CONT1 having various patterns. Here, the pattern of the gate driver control signal CONT1 may mean the waveform of the gate driver control signal CONT1 supplied to the gate driver 120 within at least one frame. The gate driver 120 may receive the gate driver control signal CONT1 corresponding to various display modes. For example, the gate driver 120 may include a shift register including a plurality of stages. The gate driver control signal CONT1 may include clock signals and control signals provided to a plurality of stages. The gate driver 120 may receive clock signals and control signals of different patterns depending on the display mode, and output gate signals of different patterns depending on the display mode on the same gate line based on the clock signals and control signals. The pulse width and/or frequency of the clock signals provided to the gate driver 120 in the normal mode may be different from the pulse width and/or frequency of the clock signals provided to the gate driver 120 in the VRR mode.

The source driver 130 may receive data DATA in the form of a digital signal from the timing controller 140, and convert the data DATA into data signals S1, S2, . . . , Sk in the form of an analog signal. Here, the data DATA may include grayscale information corresponding to each pixel PX for displaying the image signal IS on the pixel array 110. The source driver 130 may transmit a plurality of data signals S1, S2, . . . , Sk to the pixel array 110 according to a source driver control signal CONT2 provided from the timing controller 140. The source driver 130 may be referred to as a data driver.

The source driver 130 may be electrically connected to a plurality of source lines SL. The source driver 130 may transmit a plurality of data signals S1, S2, . . . , Sk to a plurality of electrically connected source lines SL.

The timing controller 140 may receive an image signal IS and a driving control signal CTRL from the host device, and control the gate driver 120 and the source driver 130. Here, the host device may be a computing device or system that controls the display device 100 to display an image desired by the user on the pixel array 110 from the outside. The timing controller 140 may generate a vertical synchronizing signal VSYNC indicating the start of each frame and a horizontal synchronizing signal HSYNC indicating the start of a horizontal line based on the image signal IS. For example, the timing controller 140 may generate the vertical synchronizing signal VSYNC based on a period during which the image signal IS is received and a period during which the image signal IS is not received. The timing controller 140 may count clock signals from the time the vertical synchronizing signal VSYNC is generated and generate the horizontal synchronizing signal HSYNC based on the counted number of clock signals. The timing controller 140 may divide the image signal IS by a frame unit based on the vertical synchronizing signal VSYNC and may generate data DATA by dividing the image signal IS on a gate line GL unit based on the horizontal synchronizing signal HSYNC.

The driving control signal CTRL provided from the host device may include control instructions and setting data for controlling the gate driver 120 and the source driver 130. The timing controller 140 may control the gate driver 120 and the source driver 130 based on the driving control signal CTRL. For example, the driving control signal CTRL may include an external vertical synchronizing signal, an external horizontal synchronizing signal, a main clock signal MCLK, and a data enable signal DE. In some implementations, the timing controller 140 may generate the vertical synchronizing signal VSYNC based on an external vertical synchronizing signal and the horizontal synchronizing signal HSYNC based on an external horizontal synchronizing signal.

The timing controller 140 may transmit the gate driver control signal CONT1 and the source driver control signal CONT2 to the gate driver 120 and the source driver 130 respectively, e.g., to synchronize the operation of the source driver 130 and the gate driver 120.

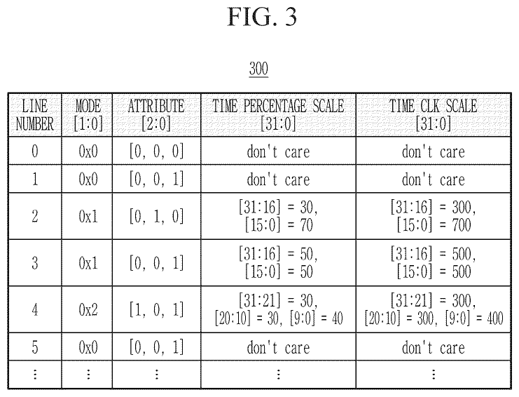

The timing controller 140 may generate the gate driver control signal CONT1 that controls the gate driver 120. In some implementations, the timing controller 140 may include a pulse generator 141 that generates the gate driver control signal CONT1 having various patterns. The pulse generator 141 may generate the gate driver control signal CONT1 based on pulse data indicating the pattern of the signal within a period corresponding to each horizontal period. The pulse data may include at least one of information about the number of toggling of the signal within each horizontal period, information about the logic level, and information about the period corresponding to the logic level. Such pulse data will be described later with reference to FIG. 3.

In some implementations, the pulse generator 141 may transition and output the gate driver control signal CONT1 within one horizontal period based on information about the number of toggling included in the pulse data. For example, if the number of toggling included in the pulse data corresponding to the first horizontal period is “0”, the pulse generator 141 may output the gate driver control signal CONT1 without changing the voltage level of the gate driver control signal CONT1 during the period corresponding to the first horizontal period. If the number of toggling included in the pulse data corresponding to the second horizontal period is “2”, the pulse generator 141 may change and output the voltage level of the gate driver control signal CONT1 twice during the period corresponding to the second horizontal period (i.e., low level→high level→low level or high level→low level→high level).

In some implementations, the pulse generator 141 may determine the voltage level of the gate driver control signal CONT1 within one horizontal period based on information about the logic level included in the pulse data and output the gate driver control signal CONT1. For example, if the logic level included in the pulse data corresponding to the first horizontal period is “0”, the pulse generator 141 may output the gate driver control signal CONT1 of the low level during the period corresponding to the first horizontal period. If the logic level included in the pulse data corresponding to the second horizontal period is “1”, the pulse generator 141 may output the gate driver control signal CONT1 of the high level during the period corresponding to the second horizontal period.

In some implementations, the pulse generator 141 may determine a time period for which the voltage level of the gate driver control signal CONT1 is maintained within one horizontal period based on a period corresponding to the logic level included in the pulse data and output the gate driver control signal CONT1. For example, if the period corresponding to the logic level included in the pulse data corresponding to the first horizontal period is “3:7”, the pulse generator 141 may output the first level gate driver control signal CONT1 for 30% of the period corresponding to the first horizontal period, and may output the second level gate driver control signal CONT1 that is different from the first level for the remaining 70% of the period. If the period corresponding to the logic level included in the pulse data corresponding to the second horizontal period is “5:3:2”, the pulse generator 141 may output the gate driver control signal CONT1 of the first level for 50% of the period corresponding to the second horizontal period, output the gate driver control signal CONT1 of the second level for the next 30% of the period, and output the gate driver control signal CONT1 of the first level for the remaining 20% of the period. Here, each of the first level and the second level may be a low level or a high level. In some implementations, each of the first level and the second level may be determined based on information about the logic level included in the pulse data.

The pixel array 110 and gate driver 120 may be implemented on the same substrate, and the source driver 130 and timing controller 140 may be configured as a single chip.

In some implementations, the pixel array 110, the gate driver 120, the source driver 130, and the timing controller 140 may be implemented on the same substrate. In some implementations, the gate driver 120, the source driver 130, and the timing controller 140 may be configured as a single chip. The gate driver 120 may be implemented as a separate semiconductor die, chip, or module and connected to the pixel array 110. Additionally, part of the gate driver 120 may be located on the substrate where the pixel array 110 is located, and the remaining part may be included in a separate chip.

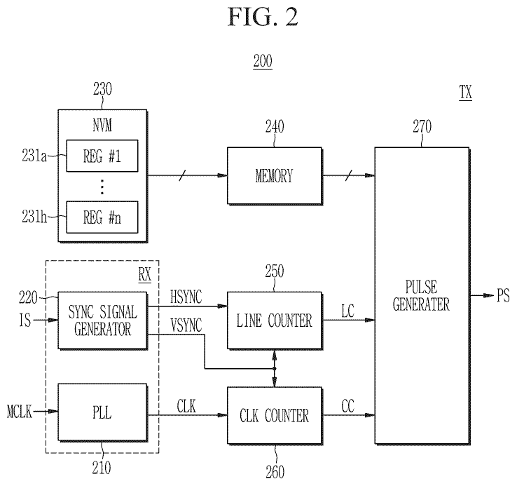

FIG. 2 is a block diagram showing examples of configurations in a timing controller.

Referring to FIG. 2, a timing controller 200 may receive the image signal IS and the main clock signal MCLK from a host device and generate a pulse signal PS. The timing controller 200 may include a receiving region, e.g., “RX region,” RX that generates an internal operating signal and a transmitting region, e.g., “TX region,” TX that delivers the signal PS to the gate driver. In some implementations, the RX region RX may include a phase locked loop (PLL) 210 and a synchronizing signal generator 220, and the TX region TX may include a non-volatile memory 230, a memory 240, a line counter 250, a clock counter 260, and a pulse generator 270.

The RX region RX may receive the image signal IS and the main clock signal MCLK, and generate the vertical synchronizing signal VSYNC, the horizontal synchronizing signal HSYNC, and a clock signal CLK.

The PLL 210 may receive the main clock signal MCLK and generate the clock signal CLK based on the main clock signal MCLK. The frequencies of the main clock signal MCLK and the clock signal CLK may be the same or different. The PLL 210 may provide the clock signal CLK to the clock counter 260. In addition, the PLL 210 may provide the clock signal CLK to internal components of the timing controller 200.

The synchronizing signal generator 220 may generate the vertical synchronizing signal VSYNC and the horizontal synchronizing signal HSYNC based on the image signal IS. In some implementations, the synchronizing signal generator 220 may receive the image signal IS and generate the vertical synchronizing signal VSYNC based on periods in which the image signal IS is received and periods in which the image signal IS is not received. The synchronizing signal generator 220 may count the clock signal CLK from the time the vertical synchronizing signal VSYNC is generated, and generate the horizontal synchronizing signal HSYNC based on the counted number of clock signals CLK. In addition, the synchronizing signal generator 220 may generate the vertical synchronizing signal VSYNC and the horizontal synchronizing signal HSYNC in various ways based on the image signal IS. At this time, the vertical synchronizing signal VSYNC and the horizontal synchronizing signal HSYNC may also be generated using an external vertical synchronizing signal and an external horizontal synchronizing signal.

The non-volatile memory 230 may store a plurality of pulse data. In some implementations, the non-volatile memory 230 may include a plurality of registers 231a, . . . , 231h. In addition, the non-volatile memory 230 may include one time programmable (OTP) memory, flash memory, phase-change memory (PRAM), resistive random-access memory (RRAM), and magneto-resistive RAM (MRAM), and the like.

Each of the plurality of registers 231a, . . . , 231h may store pulse data. The pulse data may include at least one of information about the number of toggling of each horizontal period, a logic level, and a period corresponding to the logic level.

The pulse data may be a plurality of bit data. The pulse data will be described with reference to FIG. 3.

FIG. 3 is a table showing an example of pulse data.

Referring to FIG. 3, a pulse data 300 may include line number LINE NUMBER, mode information MODE, attribute information ATTRIBUTE, time period ratio information TIME PERCENTAGE SCALE, and time period clock information TIME CLK SCALE, and the like. One pulse data 300 may correspond to one pulse signal generated by the pulse generator 270.

Line numbers may correspond to the number of gate lines GL. Line numbers may correspond to ordinal numbers of horizontal periods. Line numbers may correspond to the counting value of the horizontal synchronizing signal HSYNC. One pulse data 300 may include data corresponding to line numbers equal to or greater than the number of gate lines GL.

The mode information may indicate the number of toggling of the pulse signal within a period corresponding to the line number. The attribute information may indicate the voltage level of the pulse signal within a period corresponding to the line number.

The time period ratio information may indicate the ratio of the time period in which the voltage level of the pulse signal is maintained within the period corresponding to the line number. The time period clock information may indicate the ratio of the time period in which the voltage level of the pulse signal is maintained within the period corresponding to the line number, based on the length of the clock signal. In some implementations, the pulse data 300 may include time period ratio information or time period clock information.

The memory 240 may receive at least one of a plurality of pulse data from the non-volatile memory 230 and store the at least one pulse data. The memory 240 may transmit at least one pulse data to the pulse generator 270. The memory 240 may include volatile memory, such as static random access memory (SRAM) and dynamic random access memory (DRAM).

The line counter 250 may receive the horizontal synchronizing signal HSYNC and count the horizontal synchronizing signal HSYNC. The line counter 250 may output a counting value LC obtained by counting the horizontal synchronizing signal HSYNC to the pulse generator 270. The line counter 250 may receive the vertical synchronizing signal VSYNC and be initialized based on the vertical synchronizing signal VSYNC.

The clock counter 260 may receive the clock signal CLK and count the clock signal CLK. The clock counter 260 may output a counting value CC obtained by counting the clock signal CLK to the pulse generator 270. The clock counter 260 may receive the clock signal CLK and be initialized based on the vertical synchronizing signal VSYNC.

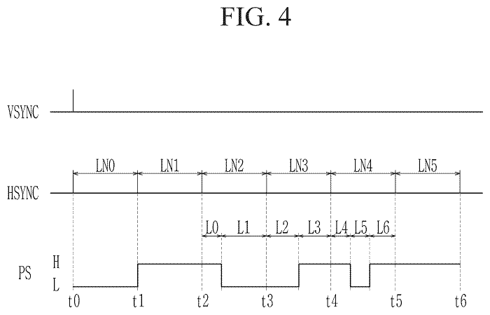

The pulse generator 270 may receive pulse data stored in the memory 240 and generate a pulse signal PS based on the pulse data. The pulse generator 270 may determine a line number to be referenced among the pulse data based on the counting value LC. For example, if the counting value LC is “0”, the pulse generator 270 may read mode information, attribute information, time period ratio information, and time period clock information of line number “0” among the pulse data. For example, if the counting value LC is “0”, the pulse generator 270 may read mode information, attribute information, time period ratio information, and time period clock information of line number “0” among the pulse data. The pulse generator 270 may generate the pulse signal PS by referring to the line number, mode information, attribute information, time period ratio information, and time period clock information of the pulse data. The operation of generating pulse signals by the pulse generator 270 will be described with reference to FIG. 4.

FIG. 4 is a timing diagram showing an example of a pulse signal generated based on pulse data.

Referring to FIGS. 3 and 4, the line counter 250 may be initialized by the vertical synchronization signal VSYNC at t0, receive the horizontal synchronizing signal HSYNC, and output the line counting value LC increased by the horizontal synchronizing signal HSYNC.

The pulse generator 270 may generate the pulse signal PS based on information about the line number of pulse data corresponding to the line counting value LC output by the horizontal synchronizing signal HSYNC.

The pulse generator 270 may read the mode information, attribute information, time period ratio information, and time period clock information of the line number “0” corresponding to the line counting value output by the horizontal synchronizing signal HSYNC of the pulse data 300 at time t0 from the memory 240.

Since the mode information of line number “0” indicates “0x0”, the pulse generator 270 may output the voltage level of the pulse signal PS during a period LN0 corresponding to line number “0” without changing. Since the attribute information of line number “0” indicates “000”, the pulse generator 270 may output the pulse signal PS having a voltage level of a first level L during the period LN0. Since the mode information of line number “0” indicates “0x0”, the pulse generator 270 may not refer to the time period ratio information, time period clock information, etc. of the pulse data of line number “0”.

The pulse generator 270 may read the mode information, attribute information, time period ratio information, and time period clock information of line number “1” corresponding to the line counting value output by the horizontal synchronizing signal HSYNC at time t1 from the memory 240. Since the mode information of line number “1” indicates “0x0”, the pulse generator 270 may output the voltage level of the pulse signal PS during a period LN1 corresponding to line number “1” without changing. Since the attribute information of line number “1” indicates “001”, the pulse generator 270 may output the pulse signal PS having a voltage level of a second level H different from the first level L during the period LN1 corresponding to the line number “1”. Since the mode information of line number “1” indicates “0x0”, the pulse generator 270 may not refer to the time period ratio information, time period clock information, etc. of the pulse data of line number “1”.

The pulse generator 270 may read the mode information, attribute information, time period ratio information, and time period clock information of line number “2” corresponding to the line counting value output by the horizontal synchronizing signal HSYNC at time t2 from the memory 240. Since the mode information of line number “2” indicates “0x1”, the pulse generator 270 may change the voltage level of the pulse signal PS once during the period LN2 corresponding to line number “2” and output the voltage level. Since the attribute information of line number “2” indicates “010”, the pulse generator 270 may output the pulse signal PS in which voltage level transitions from the second level H to the first level L during the period LN2. Since the mode information of line number “2” indicates “0x1”, the pulse generator 270 may determine the length of the period in which the voltage level of the pulse signal PS is the second level H and a period in which the voltage level of the pulse signal PS is the first level L, referring to the time period ratio information, time period clock information, etc. of the pulse data of line number “2”.

The pulse generator 270 may determine that the period LN2 includes two periods, that is, a period in which the voltage level of the pulse signal PS is the second level H and a period in which the voltage level of the pulse signal PS is the first level L. From this, the pulse generator 270 may divide the time period ratio information and/or the time period clock information of the pulse data of line number “2” into two parts.

For example, the pulse generator 270 may divide 32 bits of time period ratio information into 16 bits, such as [31:16] and [15:0]. The pulse generator 270 may determine the length of the first period (a period in which the voltage level is the second level H) based on the [31:16] value of the time period ratio information and determine the length of the second period (a period in which the voltage level is the first level L) based on the [15:0] value of the time period ratio information.

Therefore, the pulse generator 270 may determine the length of a first period L0 to be 30 and the length of a second period L1 to be 70, among the period LN2.

As another example, the pulse generator 270 may divide 32 bits of time period clock information into 16 bits, such as [31:16] and [15:0]. The pulse generator 270 may determine the length of the first period (a period in which the voltage level is the second level H) based on the [31:16] value of the time period clock information, and determine the length of the second period (a period in which the voltage level is the first level L) based on the [15:0] value of the time period clock information. Therefore, the pulse generator 270 may determine the length of the first period L0 of the period LN2 to be a period in which the counting value of the clock signal CLK is 300, and the length of the second period L1 of the period LN2 to be a period in which the counting value of the clock signal CLK is 700.

The pulse generator 270 may read the mode information, attribute information, time period ratio information, and time period clock information of line number “3” corresponding to the line counting value output by the horizontal synchronizing signal HSYNC at time t3 from the memory 240. Since the mode information of line number “3” indicates “0x1”, the pulse generator 270 may change the voltage level of the pulse signal PS once during a period LN2 corresponding to line number “3” and output the voltage level. Since the attribute information of line number “3” indicates “001”, the pulse generator 270 may output the pulse signal PS in which voltage level transitions from the first level L to the second level H during the period LN3. Since the mode information of line number “3” indicates “0x1”, the pulse generator 270 may determine the length of a period in which the voltage level of the pulse signal PS is the first level L and the length of a period in which the voltage level of the pulse signal PS is the second level H, referring to the time period ratio information, time period clock information, etc. of the pulse data of line number “3”.

For example, the pulse generator 270 may determine the length of a first period (a period in which the voltage level is the first level L) based on the [31:16] value of the time period ratio information, and determine the length of a second period (a period in which the voltage level is the second level H) based on the [15:0] value of the time period ratio information. Therefore, the pulse generator 270 may determine the length of the first period L2 to be 50 and the length of the second period L3 to be 50, among the period LN3. As another example, the pulse generator 270 may determine the length of the first period (a period in which the voltage level is the first level L) based on the [31:16] value of the time period clock information, and determine the length of the second period (a period in which the voltage level is the second level H) based on the [15:0] value of the time period clock information. Therefore, the pulse generator 270 may determine the length of the first period L2 of the period LN3 to be a period in which the counting value of the clock signal CLK is 500, and the length of the second period L3 of the period LN3 to be a period in which the counting value of the clock signal CLK is 500. In the above, it was described that the pulse generator 270 counts the lengths of periods L1, L2 and L3 using the count value of the clock counter 260. However, the pulse generator 270 may include a clock generator that generates a clock signal internally, and may count the lengths of periods L1, L2 and L3 using the clock generator.

The pulse generator 270 may read the mode information, attribute information, time period ratio information, and time period clock information of line number “4” corresponding to the line counting value output by the horizontal synchronizing signal HSYNC at time t4 from the memory 240. Since the mode information of line number “4” indicates “0x2”, the pulse generator 270 may change the voltage level of the pulse signal PS twice during a period LN4 corresponding to line number “4” and output the voltage level. Since the attribute information of line number “4” indicates “101”, the pulse generator 270 may output the pulse signal PS in which voltage level transitions from the second level H to the first level L, and from the first level L to the second level H during the period LN4. Since the mode information of line number “4” indicates “0x2”, the pulse generator 270 may determine the length of a first period L4 with a voltage level of the second level H, a second period L5 with a voltage level of the first level L, and a third period L6 with a voltage level of the second level H in the pulse signal PS, referring to the time period ratio information, time period clock information, etc. of the pulse data of line number “4”.

For example, the pulse generator 270 may determine the length of the first period L4 based on the [31:21] value of the time period ratio information, determine the length of the second period L5 based on the [20:10] value of the time period ratio information, and determine the length of the third period L6 based on the [9:0] value of the time period ratio information.

Therefore, the pulse generator 270 may determine the length of the first period L4 to be 30, the length of the second period L5 to be 30, and the length of the third period L6 to be 40, among the period LN4. As another example, the pulse generator 270 may determine the length of the first period L4 based on the [31:21] value of the time period clock information, determine the length of the second period L5 based on the [20:10] value of the time interval clock information, and determine the length of the third period L6 based on the [9:0] value of the time period clock information. Therefore, the pulse generator 270 may determine the length of the first period L4 to be a period in which the counting value of the clock signal CLK is 300, the length of the second period L5 to be a period in which the counting value of the clock signal CLK is 300, and the length of the third period L6 to be a period in which the counting value of the clock signal CLK is 400, among the period LN4.

The pulse generator 270 may read the mode information, attribute information, time period ratio information, and time period clock information of line number “5” corresponding to the line counting value output by the horizontal synchronizing signal HSYNC at time t5 from the memory 240. Since the mode information of line number “5” indicates “0x0”, the pulse generator 270 may output the voltage level of the pulse signal PS during a period LN5 corresponding to line number “5” without changing. Since the attribute information of line number “5” indicates “001”, the pulse generator 270 may output the pulse signal PS having a voltage level of the second level H different from the first level L during the period LN5 corresponding to the line number “5”. Since the mode information of line number “5” indicates “0x0”, the pulse generator 270 may not refer to the time period ratio information, time period clock information, etc. of the pulse data of line number “5”.

The pulse signal PS generated by the pulse generator 270 may be provided to the gate driver (120 in FIG. 1) as gate control signals. Accordingly, the timing controller 200 may generate pulse signals of various patterns based on pulse data, synchronizing signals VSYNC and HSYNC, and clock signal CLK.

In some implementations, since a hardwired structure is not used to generate pulse signals of various patterns, power consumption may be reduced and area overhead occupied by a logic circuit for generating pulse signals may be reduced.

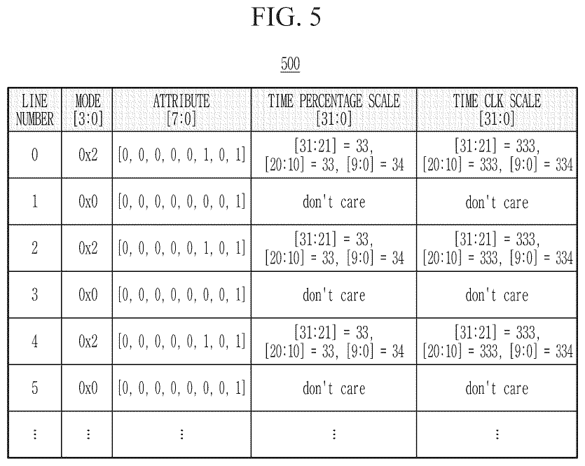

Hereinafter, with reference to FIGS. 5 to 10, pulse data and pulse signals generated based thereon will be described.

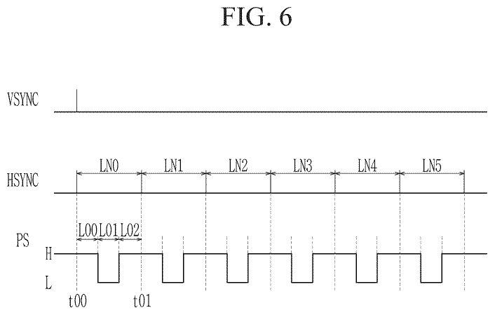

FIG. 5 is a table showing an example of pulse data, and FIG. 6 is a timing diagram showing an example of a pulse signal generated based on pulse data.

Referring to FIGS. 5 and 6, the line counter 250 may be initialized by the vertical synchronization signal VSYNC at t00, receive the horizontal synchronizing signal HSYNC, and output the line counting value increased by the horizontal synchronizing signal HSYNC. The pulse generator 270 may generate the pulse signal PS based on information about the line number of pulse data corresponding to the line counting value output by the horizontal synchronizing signal HSYNC.

The pulse generator 270 may read the mode information, attribute information, time period ratio information, and time period clock information of the line number “0” corresponding to the line counting value output by the horizontal synchronizing signal HSYNC of a pulse data 500 at time t00 from the memory 240. Since the mode information of line number “0” indicates “0x2”, the pulse generator 270 may change the voltage level of the pulse signal PS twice during the period LN0 corresponding to line number “0” and output the voltage level. Since the mode information of line number “0” indicates “0x2” and the attribute information indicates “00000101”, the pulse generator 270 may read the lowest 3 bits “101” of the attribute information. The pulse generator 270 may output the pulse signal PS in which voltage level transitions from the second level H to the first level L, and from the first level L to the second level H during the period LN0, based on the “101” of the attribute information. Since the mode information of line number “0” indicates “0x2”, the pulse generator 270 may determine the length of a first period L00 with a voltage level of the second level H, a second period L01 with a voltage level of the first level L, and a third period L02 with a voltage level of the second level H in the pulse signal PS, referring to the time period ratio information, time period clock information, etc. of the pulse data of line number “0”.

For example, the pulse generator 270 may determine the length of the first period L00 based on the [31:21] value of the time period ratio information, determine the length of the second period L01 based on the [20:10] value of the time period ratio information, and determine the length of the third period L02 based on the [9:0] value of the time period ratio information. Therefore, the pulse generator 270 may determine the length of the first period L00 to be 33, the length of the second period L01 to be 33, and the length of the third period L02 to be 34, among the period LN0. As another example, the pulse generator 270 may determine the length of the first period L00 based on the [31:21] value of the time period clock information, determine the length of the second period L01 based on the [20:10] value of the time period clock information, and determine the length of the third period L02 based on the [9:0] value of the time period clock information. Therefore, the pulse generator 270 may determine the length of the first period L00 to be a period in which the counting value of the clock signal CLK is 333, the length of the second period L01 to be a period in which the counting value of the clock signal CLK is 333, and the length of the third period L02 to be a period in which the counting value of the clock signal CLK is 334, among the period LN0.

The pulse generator 270 may read the mode information, attribute information, time period ratio information, and time period clock information of line number “1” corresponding to the line counting value output by the horizontal synchronizing signal HSYNC at time t01 from the memory 240. Since the mode information of line number “1” indicates “0x0”, the pulse generator 270 may output the voltage level of the pulse signal PS during the period LN1 corresponding to line number “1” without changing. Since the attribute information of line number “1” indicates “00000001”, the pulse generator 270 may output the pulse signal PS having a voltage level of the second level H during the period LN1 corresponding to line number “1”. Since the mode information of line number “1” indicates “0x0”, the pulse generator 270 may not refer to the time period ratio information, time period clock information, etc. of the pulse data of line number “1”.

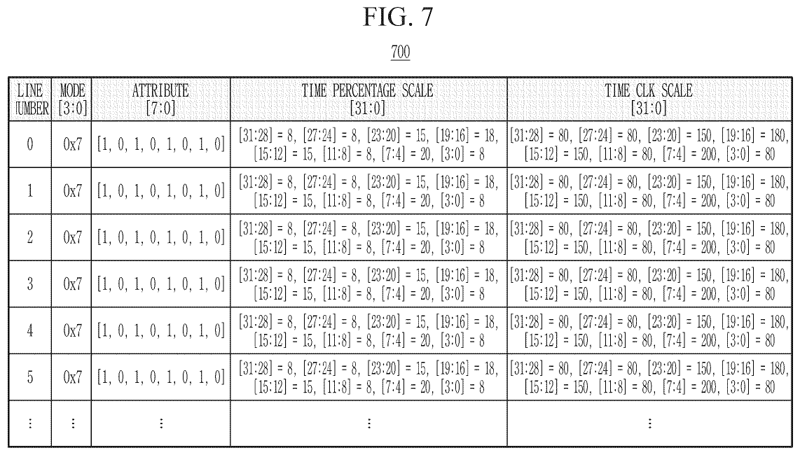

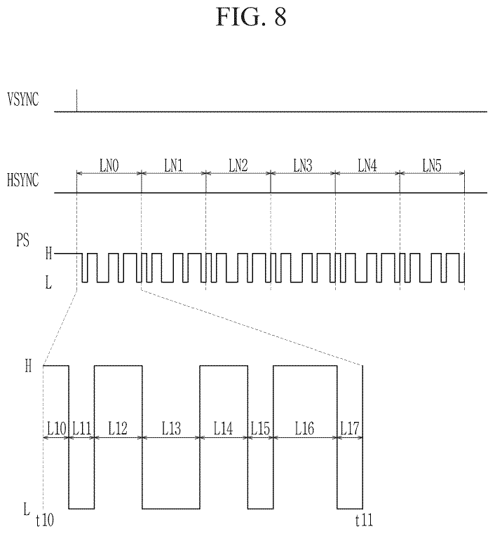

FIG. 7 is a table showing an example of pulse data, and FIG. 8 is a timing diagram showing an example of a pulse signal generated based on pulse data.

Referring to FIGS. 7 and 8, the line counter 250 may be initialized by the vertical synchronization signal VSYNC at t10, receive the horizontal synchronizing signal HSYNC, and output the line counting value increased by the horizontal synchronizing signal HSYNC. The pulse generator 270 may generate the pulse signal PS based on information about the line number of pulse data corresponding to the line counting value output by the horizontal synchronizing signal HSYNC.

The pulse generator 270 may read the mode information, attribute information, time period ratio information, and time period clock information of the line number “0” corresponding to the line counting value output by the horizontal synchronizing signal HSYNC of a pulse data 700 at time t10 from the memory 240. Since the mode information of line number “1” indicates “0x7”, the pulse generator 270 may read all 8 bits “10101010” of the attribute information. The pulse generator 270 may change the voltage level of the pulse signal PS seven times and output it during the period LN1 corresponding to line number “1” based on “10101010” of the attribute information. Since the mode information of line number “0” indicates “0x7” and the attribute information indicates “10101010”, the pulse generator 270 may output the pulse signal PS in which voltage level transitions in the order of HLHLHLHL during the period LN0. Since the mode information of line number “0” indicates “0x7”, the pulse generator 270 may determine the length of four periods L10, L12, L14 and L16 with a voltage level of the second level H and four periods L11, L13, L15 and L17 with a voltage level of the first level L in the pulse signal PS, referring to the time period ratio information, time period clock information, etc. of the pulse data of line number “0”.

For example, the pulse generator 270 may divide the time period ratio information into eight sections, determine the length of the period L10 based on the [31:28] value of the time period ratio information, determine the length of the period L11 based on the [27:24] value, determine the length of the period L12 based on the [23:20] value, determine the length of the period L13 based on the [19:16] value, determine the length of the period L14 based on the [15:12] value, determine the length of the period L15 based on the [11:8] value, determine the length of the period L16 based on the [7:4] value, and determine the length of the period L17 based on the [3:0] value.

Therefore, pulse generator 270 may determine the lengths of periods LN0, . . . , L17 within the period LN0 to be 8, 8, 15, 18, 15, 8, 20, and 8, respectively. As another example, the pulse generator 270 may determine the length of the period L10 based on the [31:28] value of the time period clock information, determine the length of the period L11 based on the [27:24] value, determine the length of the period L12 based on the [23:20] value, determine the length of the period L13 based on the [19:16] value, determine the length of the period L14 based on the [15:12] value, determine the length of the period L15 based on the [11:8] value, determine the length of the period L16 based on the [7:4] value, and determine the length of the period L17 based on the [3:0] value. Therefore, pulse generator 270 may determine the lengths of periods LN0, . . . , L17 within the period LN0 to be 80, 80, 150, 180, 150, 80, 200, and 80, respectively.

The pulse generator 270 may read the mode information, attribute information, time period ratio information, and time period clock information of the line number “1” corresponding to the line counting value output by the horizontal synchronizing signal HSYNC of a pulse data 700 at time t11 from the memory 240. The pulse generator 270 may generate the pulse signal PS of the period LN1 based on the mode information, attribute information, time period ratio information, and time period clock information of line number “1”.

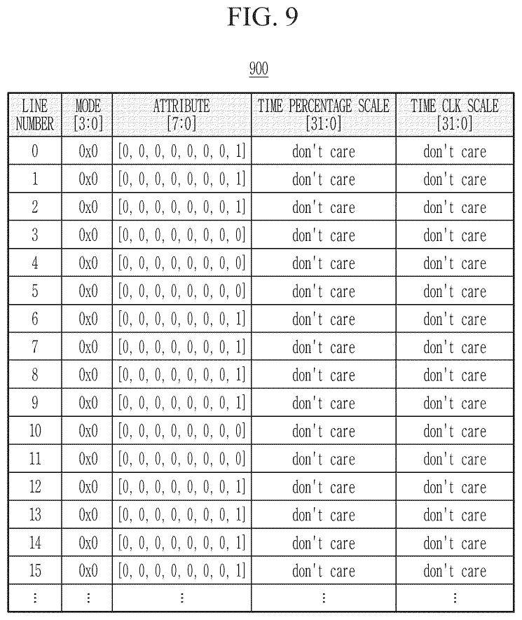

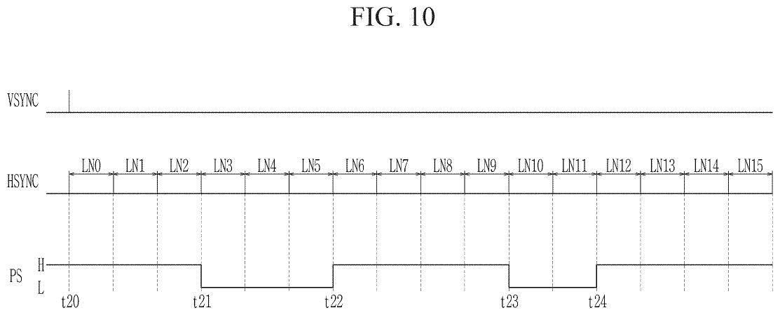

FIG. 9 is a table showing an example of pulse data, and FIG. 10 is a timing diagram showing an example of a pulse signal generated based on pulse data.

Referring to FIGS. 9 and 10, the line counter 250 may be initialized by the vertical synchronization signal VSYNC at t20, receive the horizontal synchronizing signal HSYNC, and output the line counting value increased by the horizontal synchronizing signal HSYNC. The pulse generator 270 may generate the pulse signal PS based on information about the line number of pulse data corresponding to the line counting value output by the horizontal synchronizing signal HSYNC.

The pulse generator 270 may read the mode information, attribute information, time period ratio information, and time period clock information of the line number “0” corresponding to the line counting value output by the horizontal synchronizing signal HSYNC of a pulse data 900 at time t20 from the memory 240. Since the mode information of line number “0” indicates “0x0”, the pulse generator 270 may output the voltage level of the pulse signal PS during a period LN0 corresponding to line number “0” without changing. Since the attribute information of line number “0” indicates “00000001”, the pulse generator 270 may output the pulse signal PS having a voltage level of the second level H during the period LN0. Since the mode information of line number “0” indicates “0x0”, the pulse generator 270 may not refer to the time period ratio information, time period clock information, etc. of the pulse data of line number “0”. Likewise, the pulse generator 270 may output the pulse signal PS with the voltage level of the second level H for periods LN1, LN2, LN6, . . . , LN9, LN12, . . . , LN15 based on the pulse data 900.

The pulse generator 270 may read the mode information, attribute information, time period ratio information, and time period clock information of the line number “3” corresponding to the line counting value output by the horizontal synchronizing signal HSYNC of the pulse data 900 at time t21 from the memory 240. Since the mode information of line number “3” indicates “0x0”, the pulse generator 270 may output the voltage level of the pulse signal PS during the period LN3 corresponding to line number “3” without changing. Since the attribute information of line number “3” indicates “00000000”, the pulse generator 270 may output the pulse signal PS having a voltage level of the first level L during the period LN3. Since the mode information of line number “0” indicates “0x0”, the pulse generator 270 may not refer to the time period ratio information, time period clock information, etc. of the pulse data of line number “3”. Likewise, the pulse generator 270 may output the pulse signal PS having a voltage level of the first level L during the periods LN4, LN5, LN10, and LN11 based on the pulse data 900.

Like the pulse signals PS in FIGS. 6, 8, and 10, the timing controller 200 may generate pulse signals of various patterns based on the pulse data 500, 700 and 900, the synchronizing signals VSYNC and HSYNC, and the clock signal CLK.

In some implementations, since a hardwired structure is not used to generate pulse signals of various patterns, power consumption may be reduced and area overhead occupied by a logic circuit for generating pulse signals may be reduced.

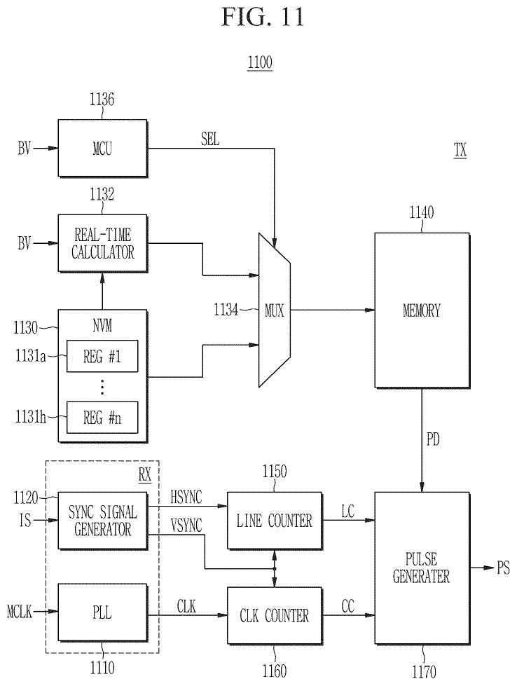

Next, with reference to FIG. 11, a timing controller will be described.

FIG. 11 is a block diagram showing examples of configurations in a timing controller.

Referring to FIG. 11, a timing controller 1100 may receive an image signal IS, brightness information BV, and a main clock signal MCLK from a host device, and generate a pulse signal PS. The timing controller 1100 may generate the pulse signal PS based on the brightness information BV. The timing controller 1100 may include the RX region RX that generates an internal operating signal and the TX region TX that delivers the signal PS to the gate driver. In some implementations, the RX region RX may include a phase locked loop PLL 1110 and a synchronizing signal generator 1120, and the TX region TX may include a non-volatile memory 1130, a real-time calculator 1132, a multiplexer (MUX) 1134, a microcontroller unit (MCU) 1136, a memory 1140, a line counter 1150, a clock counter 1160, and a pulse generator 1170. Description of the constituent elements of the timing controller 1100 of FIG. 11 that are the same or similar to the constituent elements of the timing controller 200 of FIG. 2 will be omitted.

The real-time calculator 1132 may receive brightness information BV from the host device and pulse data from the non-volatile memory 1130. The real-time calculator 1132 may change pulse data based on brightness information BV. Brightness information BV may indicate the overall brightness value of one frame image. Brightness information BV may be calculated based on a one-frame image signal in the host device. For example, the value of brightness information BV may be 0 to 255. The real-time calculator 1132 may include a plurality of registers. Each of the plurality of registers may store changed pulse data.

In some implementations, the real-time calculator 1132 may change pulse data if the brightness information BV is below a predetermined reference value. For example, when the real-time calculator 1132 receives the image signal IS of one frame, if the value of the received brightness information BV is 30 or less, the real-time calculator 1132 may change the pulse data.

In some implementations, the real-time calculator 1132 may change information about the period corresponding to the logic level of the pulse data based on the brightness information BV. For example, the real-time calculator 1132 may change the information about the period corresponding to the logic level of the pulse data, so that the timing, time length, number, etc. of the period when the voltage level of the pulse signal PS is at the enable level may be changed, based on the value of the brightness information BV. If the value of the brightness information BV is less than or equal to a predetermined reference value, the real-time calculator 1132 may change information about the period corresponding to the logic level of the pulse data to shorten the length of the period when the voltage level of the pulse signal PS within one frame is at the enable level in response to the value of the brightness information BV. In some implementations, the real-time calculator 1132 may change information about the number of toggling and/or logic level of the pulse data based on the brightness information BV. For example, the real-time calculator 1132 may change information about the number of toggling of the pulse data so that the number of toggling of the pulse signal PS increases or decreases, based on the value of the brightness information BV. If the value of the brightness information BV is less than or equal to a predetermined reference value, the real-time calculator 1132 may change the information about the number of toggling of the pulse data, so that the number of toggling of the pulse signal PS generated by the pulse data within a frame period corresponding to the value of the brightness information BV decreases by 2n (n is a positive integer) times.

The MCU 1136 may receive brightness information BV and output a selection signal SEL based on the brightness information BV. If the value of the brightness information BV is less than or equal to a predetermined reference value, the MCU 1136 may output the selection signal SEL to control the multiplexer 1134 so that pulse data from the real-time calculator 1132 is output to the memory 1140. If the value of brightness information BV exceeds a predetermined reference value, the MCU 1136 may output the selection signal SEL to control the multiplexer 1134 so that pulse data from the non-volatile memory 1130 is output to the memory 1140.

The timing controller 1100 may generate the pulse signal PS with a changed pattern based on the brightness information BV. Therefore, in some implementations, using the timing controller 1100 makes it possible to generate gate control signals of various patterns while reducing the capacity of the non-volatile memory 1130.

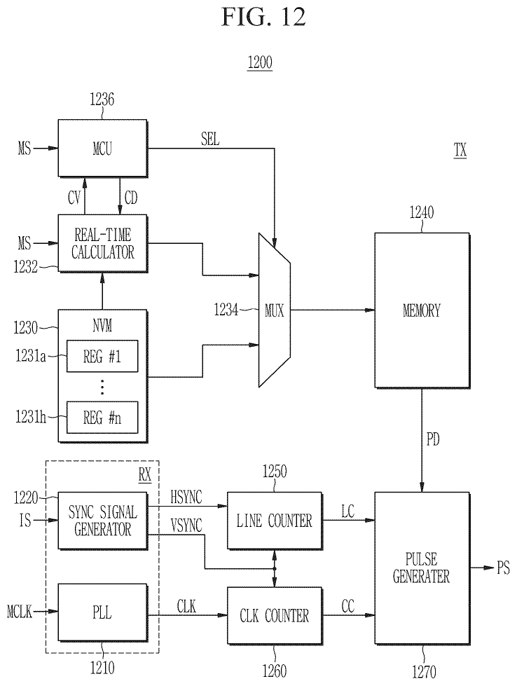

FIG. 12 is a block diagram showing examples of configurations in a timing controller.

Referring to FIG. 12, a timing controller 1200 may receive the image signal IS, the mode signal MS, and the main clock signal MCLK from a host device, and generate the pulse signal PS. The timing controller 1200 may generate the pulse signal PS based on the mode signal MS. The timing controller 1200 may include the RX region RX that generates an internal operating signal and the TX region TX that delivers the signal PS to the gate driver. In some implementations, the RX region RX may include a PLL 1210 and a synchronizing signal generator 1220, and the TX region TX may include a non-volatile memory 1230, a real-time calculator 1232, and a multiplexer (MUX) 1234, a microcontroller unit (MCU) 1236, a memory 1240, a line counter 1250, a clock counter 1260, and a pulse generator 1270. Description of the constituent elements of the timing controller 1200 of FIG. 12 that are the same or similar to the constituent elements of the timing controller 200 of FIG. 11 will be omitted.

The real-time calculator 1232 may receive the mode signal MS from the host device and pulse data from the non-volatile memory 1230. The real-time calculator 1232 may change pulse data based on the mode signal MS. The mode signal MS may indicate the display mode. The real-time calculator 1232 may include a plurality of registers. Each of the plurality of registers may store changed pulse data.

In some implementations, the real-time calculator 1232 may change pulse data in response to the display mode indicated by the mode signal MS. For example, when the mode signal MS indicates the first mode, the real-time calculator 1232 may change the pulse data. If the mode signal MS indicates the second mode, the real-time calculator 1232 may not change the pulse data.

In some implementations, the real-time calculator 1232 may change information about the period corresponding to the logic level of the pulse data based on the mode signal MS. For example, the real-time calculator 1232 may change the information about the period corresponding to the logic level of the pulse data, so that the timing, time length, number, etc. of the period when the voltage level of the pulse signal PS is at the enable level may be changed, based on mode signal MS. When the mode signal MS indicates the first mode, the real-time calculator 1232 may change information about the period corresponding to the logic level of the pulse data, so that the length of the period in which the voltage level of the pulse signal PS during one frame in an enable level is shortened. When the mode signal MS indicates the first mode, the real-time calculator 1232 may change the information about the period corresponding to the logical level of pulse data, so that the period at which the voltage level of the pulse signal PS during one frame is divided into a plurality of periods spaced at substantially equal intervals and having substantially equal durations.

In some implementations, the real-time calculator 1232 may change information about the number of toggling and/or logic level of the pulse data based on the mode signal MS. For example, when the mode signal MS indicates the first mode, the real-time calculator 1232 may change information about the number of toggling of the pulse data so that the number of toggling of the pulse signal PS increases or decreases. If the value of the mode signal MS indicates the first mode, the real-time calculator 1232 may change the information about the number of toggling of the pulse data, so that the number of toggling of the pulse signal PS generated by the pulse data within a frame period corresponding to the value of the mode signal MS decreases by 2n (n is a positive integer) times.

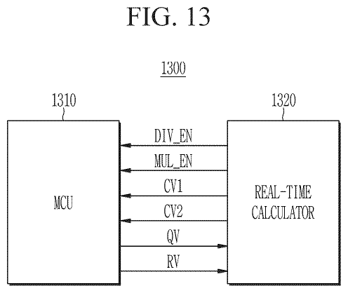

The real-time calculator 1232 may transmit a value to be calculated CV to the MCU 1236 and receive a calculated value CD from the MCU 1236. The real-time calculator 1232 may receive values from the non-volatile memory 1230 and transmit the received values to the MCU 1236 as the value to be calculated CV. In some implementations, the real-time calculator 1232 may transmit the value to be calculated CV, which requires complex calculations such as multiplication and division, to the MCU 1236. The MCU 1236 may perform a calculation on the value to be calculated CV and transmit the calculated value CD to the real-time calculator 1232. This will be described with reference to FIG. 13.

FIG. 13 is a block diagram specifically showing examples of configurations in a timing controller.

Referring to FIG. 13, the MCU 1310 and the real-time calculator 1320 may transmit and receive signals to and from each other. The MCU 1310 may calculate values received from the real-time calculator 1320 and transmit the calculated result value to the real-time calculator 1320.

In some implementations, the real-time calculator 1320 may transmit a division calculation enable signal DIV_EN and value to be calculateds CV1 and CV2 (for example, a dividend CV1 and a divisor CV2) to the MCU 1310. The MCU 1310 may receive the division calculation enable signal DIV_EN and the value to be calculateds CV1 and CV2, perform a division calculation of the dividend CV1 and divisor CV2, and transmit result values QV and RV (for example, a quotient QV and a remainder RV) to the real-time calculator 1320.

In some implementations, real-time calculator 1320 may transmit a multiplication calculation enable signal MUL_EN and value to be calculateds CV1 and CV2 (for example, a multiplicand CV1 and a multiplier CV2) to the MCU 1310. The MCU 1310 may receive the multiplication calculation enable signal MUL_EN and the value to be calculateds CV1 and CV2, perform the multiplication calculation of the multiplicand CV1 and the multiplier CV2, and transmit the result value QV to the real-time calculator 1320.

The MCU 1236 may receive the mode signal MS and output the selection signal SEL based on the mode signal MS. When the mode signal MS indicates the first mode, the MCU 1236 may output the selection signal SEL to control the multiplexer 1234 so that pulse data from the real-time calculator 1232 is output to the memory 1240. When the mode signal MS indicates the second mode, the MCU 1236 may output the selection signal SEL to control the multiplexer 1234 so that pulse data from the non-volatile memory 1230 is output to the memory 1240.

The timing controller 1200 may generate the pulse signal PS with a changed pattern based on the mode signal MS. Therefore, in some implementations, using the timing controller 1200 makes it is possible to generate gate control signals of various patterns while reducing the capacity of the non-volatile memory 1230.

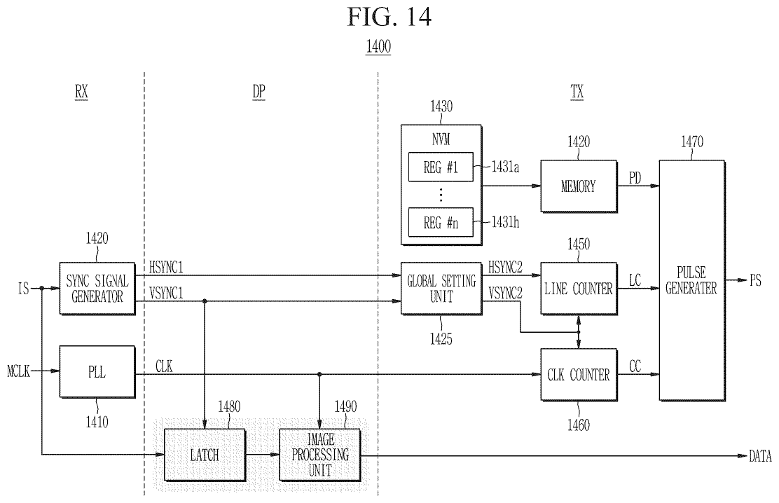

FIG. 14 is a block diagram showing examples of configurations in a timing controller.

Referring to FIG. 14, a timing controller 1400 may receive the image signal IS and the main clock signal MCLK from a host device and generate the pulse signal PS. The timing controller 1400 may include the RX region RX that generates an internal operating signal, a data path DP that processes the received image signal IS, and the TX region TX that transmits the signal PS to the gate driver.

In some implementations, the RX region RX may include a PLL 1410 and a synchronizing signal generator 1420, the data path DP may include a latch 1480 and an image processing unit 1490, and the TX region TX may include a global setting unit 1425, a volatile memory 1430, a memory 1440, a line counter 1450, a clock counter 1460, and a pulse generator 1470. Description of the constituent elements of the timing controller 1400 of FIG. 14 that are the same or similar to the constituent elements of the timing controller 200 of FIG. 2 will be omitted.

The synchronizing signal generator 1420 may generate a vertical synchronizing signal VSYNC1 and a horizontal synchronizing signal HSYNC1 based on the image signal IS.

The latch 1480 may receive the image signal IS and divide the image signal IS by a frame unit based on the vertical synchronizing signal VSYNC1. In some implementations, the latch 1480 may divide the image signal IS divided by a frame unit into horizontal periods based on the horizontal synchronizing signal HSYNC.

The image processing unit 1490 may receive the divided image signal IS from the latch 1480 and perform image processing. The image processing unit 1490 may output image-processed data DATA.

The global setting unit 1425 may receive the vertical synchronizing signal VSYNC1 and the horizontal synchronizing signal HSYNC1 from the synchronizing signal generator 1420 and generate a vertical synchronizing signal VSYNC2 and a delayed horizontal synchronizing signal HSYNC2 by delaying the vertical synchronizing signal VSYNC1 and the horizontal synchronizing signal HSYNC1 by a predetermined time.

Image signal processing operations in the latch 1490 and the image processing unit 1490 may delay output of data DATA. Therefore, when the pulse signal PS, i.e., the gate control signal, is generated based on the vertical synchronizing signal VSYNC1 and the horizontal synchronizing signal HSYNC1, the data signal generated based on the data DATA and the gate signal generated based on the gate control signal may not be synchronized. The pulse generator 1470 may generate and output the pulse signal PS based on the counting value of the delayed horizontal synchronizing signal HSYNC2 delayed by the global setting unit 1425. The global setting unit 1425 may generate the delayed vertical synchronizing signal VSYNC2 and the delayed horizontal synchronizing signal HSYNC2 by reflecting the delay of data DATA output according to the image signal processing operation in the image processing unit 1490. Accordingly, the data signal generated based on the delayed data DATA and the gate signal generated based on the pulse signal PS may be synchronized.

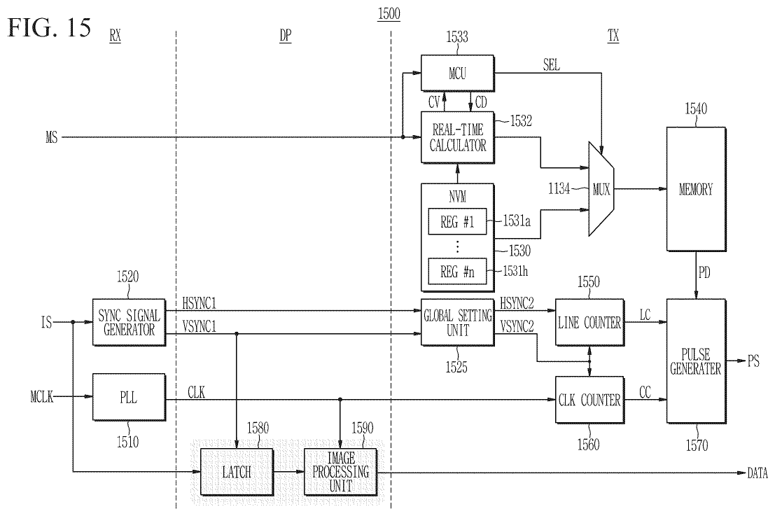

FIG. 15 is a block diagram showing examples of configurations in a timing controller.

Referring to FIG. 15, a timing controller 1500 may receive the image signal IS, the mode signal MS, and the main clock signal MCLK from a host device, and generate the pulse signal PS. The timing controller 1500 may generate the pulse signal PS based on the mode signal MS. The timing controller 1500 may include the RX region RX that generates an internal operating signal, the data path DP that processes the received image signal IS, and the TX region TX that transmits the signal PS to the gate driver.

In some implementations, the RX region RX may include a PLL 1510 and a synchronizing signal generator 1520, the data path DP may include a latch 1580 and an image processing unit 1590, and the TX region TX may include a global setting unit 1525, a non-volatile memory 1530, a real-time calculator 1532, a MUC 1533, a multiplexer 1534, a memory 1540, a line counter 1550, a clock counter 1560, and a pulse generator 1570. Description of the constituent elements of the timing controller 1500 of FIG. 15 that are the same or similar to the constituent elements of the timing controller 1200 of FIG. 12 will be omitted.

The synchronizing signal generator 1520 may generate the vertical synchronizing signal VSYNC1 and a horizontal synchronizing signal HSYNC1 based on the image signal IS.

The latch 1580 may receive the image signal IS and divide the image signal IS by a frame unit based on the vertical synchronizing signal VSYNC1. In some implementations, the latch 1580 may divide the image signal IS divided by a frame unit into horizontal periods based on the horizontal synchronizing signal HSYNC.

The image processing unit 1590 may receive the divided image signal IS from the latch 1580 and perform image processing. The image processing unit 1590 may output image-processed data DATA.

The global setting unit 1525 may receive the vertical synchronizing signal VSYNC1 and the horizontal synchronizing signal HSYNC1 from the synchronizing signal generator 1520 and generate the vertical synchronizing signal VSYNC2 and the delayed horizontal synchronizing signal HSYNC2 by delaying the vertical synchronizing signal VSYNC1 and the horizontal synchronizing signal HSYNC1 by a predetermined time.

Data processing operations in the latch 1580 and the image processing unit 1590 may delay output of data DATA. Therefore, when the pulse signal PS, i.e., the gate control signal, is generated based on the vertical synchronizing signal VSYNC1 and the horizontal synchronizing signal HSYNC1, the data signal generated based on the data DATA and the gate signal generated based on the gate control signal may not be synchronized. The pulse generator 1570 may generate and output the pulse signal PS based on the counting value of the delayed horizontal synchronizing signal HSYNC2 delayed by the global setting unit 1525. Accordingly, the data signal generated based on the delayed data DATA and the gate signal generated based on the pulse signal PS may be synchronized.

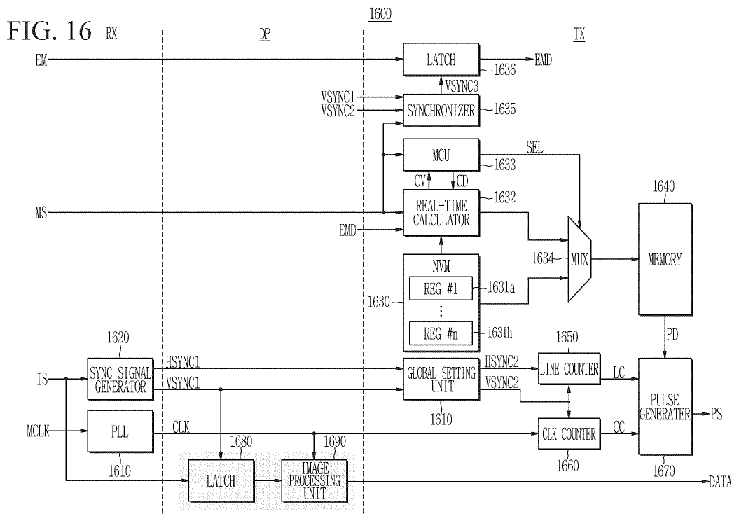

FIG. 16 is a block diagram showing examples of configurations in a timing controller.

Referring to FIG. 16, a timing controller 1600 may receive the image signal IS, the mode signal MS, the light emitting period information EM, and the main clock signal MCLK from the host device, and receive the pulse signal PS. The timing controller 1600 may generate the pulse signal PS based on the mode signal MS. The timing controller 1600 may include the RX region RX that generates an internal operating signal, the data path DP that processes the received image signal IS, and the TX region TX that transmits the signal PS to the gate driver.

In some implementations, the RX region RX may include a PLL 1610 and a synchronizing signal generator 1620, the data path DP may include a latch 1680 and an image processing unit 1690, and the TX region TX may include a global setting unit 1625, a non-volatile memory 1630, a real-time calculator 1632, an MCU 1633, a multiplexer 1634, a synchronizer 1635, a latch 1636, a memory 1640, a line counter 1650, a clock counter 1660, and a pulse generator 1670.

Description of the components of the timing controller 1600 of FIG. 16 that are the same or similar to the components of the timing controller 1500 of FIG. 15 will be omitted.

The host device may provide the mode signal MS indicating the first mode and the light emitting period information EM to the timing controller 1600. The light emitting period information EM may include information about the light emitting period of a pixel within one frame.

The synchronizer 1635 may output one VSYNC3 of the vertical synchronizing signal VSYNC1 or the vertical synchronizing signals VSYNC2.

The synchronizer 1635 may select the vertical synchronizing signal VSYNC1 or the vertical synchronizing signal VSYNC2 based on the mode signal MS. For example, when the mode signal MS indicates the first mode, the synchronizer 1635 may output the vertical synchronizing signal VSYNC1. And when the mode signal MS indicates the second mode, the synchronizer 1635 may output the vertical synchronizing signal VSYNC2.

The latch 1636 may latch the light emitting period information EM based on one VSYNC3 of the vertical synchronizing signal VSYNC1 or the vertical synchronizing signal VSYNC2. The light emitting period information EM may be latched by the latch 1636 and output as a light emitting period data EMD.

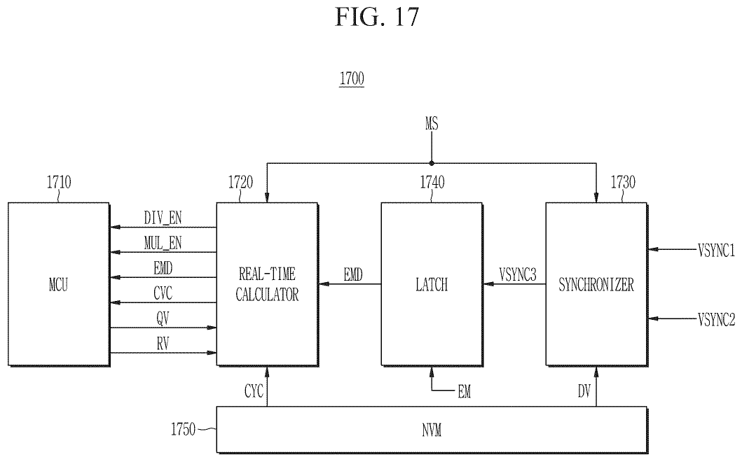

The real-time calculator 1632 may change pulse data in response to the display mode indicated by the mode signal MS. For example, when the mode signal MS indicates the first mode, the real-time calculator 1632 may read the light emitting period repetition value from the non-volatile memory 1630. The real-time calculator 1632 may change the pulse data by referring to the light emitting period data EMD and the light emitting period repetition value. In some implementations, the real-time calculator 1632 may transmit the light emitting period data EMD and the light emitting period repetition value as the value to be calculated CV to the MCU 1633. The MCU 1633 may perform a calculation on the value to be calculated CV and transmit the calculated value CD to the real-time calculator 1632. This will be described with reference to FIG. 17.

FIG. 17 is a block diagram showing examples of configurations in a timing controller.

Referring to FIG. 17, an MCU 1710 and a real-time calculator 1720 may transmit and receive signals to each other. The MCU 1710 may calculate values EMD and CYC received from the real-time calculator 1720 and transmit the calculated result value to the real-time calculator 1720.

A synchronizer 1730 receives the mode signal MS and may output the vertical synchronizing signal VSYNC2 when the mode signal MS indicates the first mode. The synchronizer 1730 may output the vertical synchronizing signal VSYNC1 when the mode signal MS indicates the second mode. In some implementations, when the mode signal MS indicates a third mode, the synchronizer 1730 may read a delay value DV from a non-volatile memory 1750, and delay and output the delay value DV on the vertical synchronizing signal VSYNC1 or the vertical synchronizing signal VSYNC2.

The real-time calculator 1720 receives the mode signal MS and may read a light emitting period repetition value CYC from the non-volatile memory 1750 when the mode signal MS indicates the first mode. In some implementations, the real-time calculator 1720 may transmit the division calculation enable signal DIV_EN and the value to be calculateds EMD and CYC (for example, a dividend EMD and a divisor CYC) to the MCU 1710. The MCU 1710 may receive the division calculation enable signal DIV_EN and the value to be calculateds EMD and CYC, perform a division calculation of the dividend EMD and the divisor CYC, and transmit the result values QV and RV (for example, the quotient QV and the remainder RV) to the real-time calculator 1720. Quotient QV may indicate the length of each of a plurality of light emitting periods within one frame.

The real-time calculator 1720 receives the mode signal MS and may read pulse data from the non-volatile memory 1750 when the mode signal MS indicates the first mode. The real-time calculator 1720 may change at least one of the number of toggling of pulse data, information about the logic level, and information about the period corresponding to the logic level, so that the light emitting period of one frame is divided into a plurality of light emitting periods spaced at substantially equal intervals and having substantially equal durations (for example, QV, QV+E (where E is a positive number satisfying E<RV)).

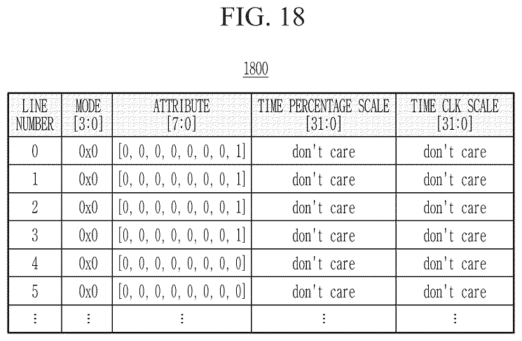

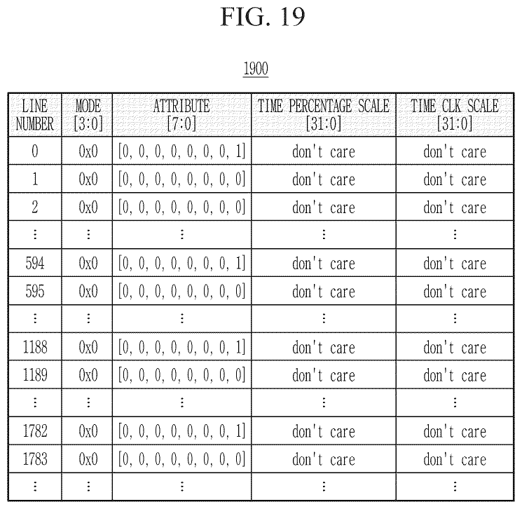

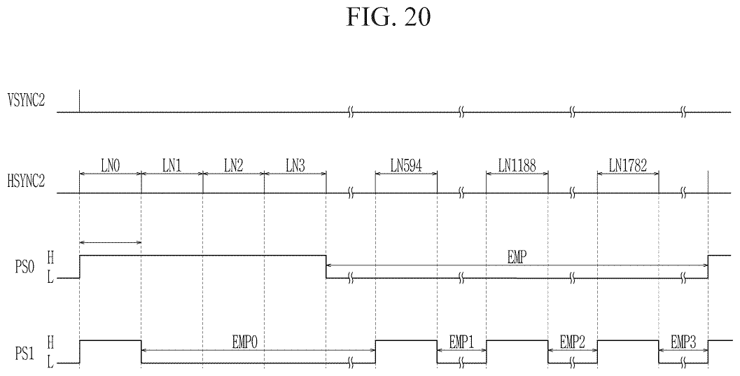

FIG. 18 is a table showing an example of pulse data, FIG. 19 is a table showing an example of changed pulse data, and FIG. 20 is a timing diagram showing an example of a pulse signal generated based on pulse data.

FIG. 19 shows the pulse data in which the real-time calculator 1720 changed the pulse data of FIG. 18, when the light emitting period data EMD is 4, the light emitting period repetition value CYC is 4, the length QV of each of the plurality of light emitting periods is 1, and the remainder RV is calculated as 0.

Referring to FIGS. 18 and 20, since the attribute information of line numbers “0” to “3” of a pulse data 1800 indicates “00000001”, a pulse generator 1770 may output a pulse signal PS0 having a voltage level of the second level H during the period LN0 to LN3 corresponding to line numbers “0” to “3”. Since the attribute information of line number “4” indicates “00000000”, the pulse generator 1770 may output the pulse signal PS0 with a voltage level of the first level L after the period LN4 corresponding to line number “4”.

Referring to FIGS. 19 and 20, since the attribute information of line numbers “0”, “594”, “1188”, and “1782” of a pulse data 1900 indicates “00000001”, the pulse generator 1770 may output a pulse signal PS1 having a voltage level with the second level H during periods LN0, LN594, LN1188 and LN1782 corresponding to the line numbers “0”, “594”, “1188” and “1782”. Since the attribute information of line numbers “1”, “2”, “595”, “1189” and “1783” indicates “00000000”, the pulse generator 1770 may output the pulse signal PS1 having a voltage level with the first level L during periods LN1, LN2, LN595, LN1189 and LN1783 corresponding to the line numbers “1”, “2”, “595”, “1189” and “1783”.

In other words, the pulse generator 1770 may divide a light emitting period EMP into four light emitting periods EMP0, EMP1, EMP2 and EMP3, and generate the pulse data 1900 based on the pulse data 1800, the length of each light emitting period QV, and the remainder RV, so that each of the light emitting periods EMP0, EMP1, EMP2, and EMP3 is spaced at substantially equivalent time intervals LN594, LN1188, and LN1782.

Referring again to FIG. 16, the MCU 1633 may receive the mode signal MS and output the selection signal SEL based on the mode signal MS. When the mode signal MS indicates the first mode, the MCU 1633 may output the selection signal SEL to control the multiplexer 1634 so that pulse data from the real-time calculator 1632 is output to the memory 1640. When the mode signal MS indicates the second mode, the MCU 1633 may output the selection signal SEL to control the multiplexer 1634 so that pulse data from the non-volatile memory 1630 is output to the memory 1640.

The timing controller 1600 may generate the pulse signal PS with a changed pattern based on the mode signal MS. Therefore, in some implementations, using the timing controller 1600 makes it is possible to generate gate control signals of various patterns while reducing the capacity of the non-volatile memory 1630.

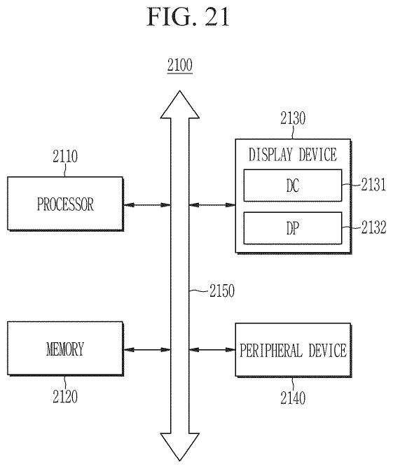

FIG. 21 is a diagram of an example of a display system.

Referring to FIG. 21, a display system 2100 includes a processor 2110, a memory 2120, a display device 2130, and a peripheral device 2140 that are electrically connected to a system bus 2150.

The processor 2110 controls the input and output of data from the memory 2120, the display device 2130, and the peripheral device 2140 and may perform image processing of image data transmitted between the corresponding devices.

Memory 2120 may include volatile memory such as dynamic random access memory (DRAM) and/or non-volatile memory such as flash memory. The memory 2120 may include DRAM, phase-change random access memory (PRAM), magnetic random access memory (MRAM), resistive random access memory (ReRAM), ferroelectric random access memory (FRAM), NOR flash memory, NAND flash memory, and fusion flash memory (for example, memory combined with static random access memory (SRAM) buffer and NAND flash memory and NOR interface logic). The memory 2120 may store image data obtained from the peripheral device 2140 or image signals processed by the processor 2110.

The display device 2130 includes a driving circuit 2131 and a display panel 2132, and the driving circuit 2131 may display image data applied through the system bus 2150 on the display panel 2132. The driving circuit 2131 may generate a gate signal that drives the display panel 2132 based on pulse data. The pulse data may include at least one of information about the number of toggling of each horizontal period, a logic level, and a period corresponding to the logic level. The driving circuit 2131 may include the timing controller described in FIGS. 1 to 20.

The peripheral device 2140 may be a device that converts moving images or still images, such as a camera, scanner, or webcam, into electrical signals. Image data obtained through the peripheral device 2140 may be stored in the memory 2120 or displayed on the display panel 2132 in real time.

The display system 2100 may be provided in a mobile electronic product such as a smartphone, but is not limited thereto, and may be provided in various types of electronic products that display images.

In some implementations, each constituent element or combination of two or more constituent elements described with reference to FIGS. 1 to 21 may be implemented as a digital circuit, a programmable or non-programmable logic device or array, or an application specific integrated circuit (ASIC), and the like.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A timing controller, comprising:
a non-volatile memory configured to store pulse data including information about at least one of information about a number of toggling of each signal in a plurality of horizontal periods, information about a logic level, and information about a period corresponding to the logic level; and
a pulse generator configured to generate control signals corresponding to the plurality of horizontal periods based on the pulse data.

2. The timing controller of claim 1, wherein the pulse generator is further configured to toggle the control signals based on information about the number of toggling.

3. The timing controller of claim 1, wherein the pulse generator is further configured to determine a voltage level of the control signals based on information about the logic level.

4. The timing controller of claim 1, wherein the pulse generator is further configured to determine a period maintaining a voltage level of the control signals based on information about the period corresponding to the logic level.

5. The timing controller of claim 4, further comprising a clock counter configured to count a clock signal,
wherein the pulse generator is further configured to maintain the voltage level of the control signals for a period corresponding to the logic level based on a counting value of the clock counter.

6. The timing controller of claim 1, further comprising:
a real-time calculator configured to i) receive a mode signal and the pulse data and ii) change the pulse data based on the mode signal;
a multiplexer configured to selectively output the pulse data and the pulse data changed by the real-time calculator; and
a memory configured to i) store pulse data output from the multiplexer and ii) provide the pulse data to the pulse generator.

7. The timing controller of claim 6, further comprising:
a line counter configured to count a horizontal synchronizing signal and initialized by a vertical synchronizing signal,
wherein the pulse generator is further configured to i) determine a horizontal period corresponding to the horizontal synchronizing signal based on a counting value of the line counter and ii) generate a control signal corresponding to the horizontal period based on information about at least one of information about the number of toggling of a signal of the horizontal period of the pulse data, information about a logic level, and information about the period corresponding to the logic level.

8. The timing controller of claim 7, further comprising a global setting unit configured to:
receive the horizontal synchronizing signal and the vertical synchronizing signal, and
output a delayed horizontal synchronizing signal obtained by delaying the horizontal synchronizing signal and a delayed vertical synchronizing signal obtained by delaying the vertical synchronizing signal to the line counter.

9. The timing controller of claim 8, further comprising:
a latch configured to i) latch information about a light emitting period and ii) output the latched latch information about the light emitting period to the real-time calculator; and
a synchronizer configured to output the vertical synchronizing signal or the delayed vertical synchronizing signal to the latch.

10. The timing controller of claim 8, further comprising an image processing unit configured to i) process an image signal and ii) output data based on the processed image signal,
wherein the global setting unit is further configured to output the delayed horizontal synchronizing signal and the delayed vertical synchronizing signal by reflecting the delay of the data output in response to the image processing unit processing the image signal.

11. The timing controller of claim 7, further comprising a synchronizing signal generator configured to generate the vertical synchronizing signal and the horizontal synchronizing signal based on an image signal.

12. The timing controller of claim 6, further comprising a microcontroller unit configured to receive the mode signal and outputting a selection signal that controls the multiplexer based on the mode signal.

13. The timing controller of claim 12, wherein the real-time calculator is further configured to provide a value to be calculated to the microcontroller unit, receive a calculated value from the microcontroller unit, and change the pulse data based on the calculated value.

14. The timing controller of claim 13, wherein the microcontroller unit is further configured to perform, on the value to be calculated, at least one of multiplication and division calculations.

15. A display driving device, comprising:
a gate driver configured to generate a gate signal to be applied to a pixel based on a gate control signal; and
a timing controller configured to i) count a plurality of horizontal synchronizing signals indicating a plurality of horizontal periods and ii) generate the gate control signal based on information about a waveform of the gate control signal corresponding to the horizontal period corresponding to a counting value among the plurality of horizontal periods.

16. The display driving device of claim 15, wherein the information about the waveform of the gate control signal includes at least one of information about a number of toggling of the gate control signal, information about a logic level of the gate control signal, and information about the period corresponding to the logic level of the gate control signal.

17. The display driving device of claim 16, wherein the timing controller is further configured to output the gate control signal in which a voltage level changes depending on the number of toggling of the gate control signal during the horizontal period.

18. The display driving device of claim 16, wherein the timing controller is further configured to output the gate control signal having a voltage level corresponding to the logic level of the gate control signal during the horizontal period.

19. The display driving device of claim 16, wherein the timing controller is further configured to output the gate control signal having a voltage level corresponding to the logic level during a period corresponding to the logic level of the gate control signal within the horizontal period.

20. A display device, comprising:
a pixel array including a gate line and a plurality of pixels connected to the gate line;
a gate driver configured to output a gate signal to the gate line based on a gate driver control signal; and
a timing controller configured to control a voltage level of the gate driver control signal based on pulse data indicating a pattern of a signal within a period corresponding to each of a plurality of horizontal periods.
